(19) United States
(12) Patent Application Publication
(10) Pub. No.: US 2025/0085529 A1
(43) Pub. Date: Mar. 13, 2025

(54) LENS MIRROR ARRAY

(71) Applicant: Toshiba Tec Kabushiki Kaisha, Tokyo (JP)

(72) Inventors: Takeshi WATANABE, Yokohama (JP); Takashi SHIRAISHI, Kawasaki (JP)

(73) Assignee: Toshiba Tec Kabushiki Kaisha, Tokyo (JP)

(21) Appl. No.: 18/463,801

(22) Filed: Sep. 8, 2023

(51) Int. Cl. G02B 26/12; G03G 15/04; H04N 1/028

(52) U.S. Cl. CPC G02B 26/12; G03G 15/04036; H04N 1/0281; H04N 1/02835

(57) ABSTRACT

A lens mirror array includes a plurality of optical elements arrayed in a main scanning direction. Each of the optical elements includes an incident surface, at least one reflection surface, and an emission surface. The incident surface transmits and converges light made incident thereon. The reflection surface has positive optical power for reflecting and converging the light made incident via the incident surface. The emission surface emits the light reflected by the reflection surface. The lens mirror array includes a plurality of grooves and a light blocking member. The plurality of grooves are provided among a plurality of the reflection surfaces arranged in the main scanning direction of the plurality of optical elements. The light blocking member is provided in the plurality of grooves.

### FIELD

Embodiments described herein relate generally to, for example, a lens mirror array used in a scanner and an exposing device of an image forming apparatus installed in a workplace.

### BACKGROUND

A scanner of a copying machine includes a lens-mirror integrated array (hereinafter referred to as lens mirror array) for refracting and reflecting light reflected on an original document surface and condensing the light on a CCD sensor or the like. The lens mirror array includes, for example, a plurality of optical elements arrayed in a main scanning direction. The lens mirror array can be formed by, for example, integral molding of transparent resin.

Each of the optical elements includes an incident-side lens surface on which reflected light from an original document is made incident, an emission-side lens surface that emits the incident light toward the CCD sensor, and at least one reflection surface that guides the light made incident via the incident-side lens surface to the emission-side lens surface. The at least one reflection surface includes a reflection surface of a free curved surface having positive optical power for converging reflected light. In order to narrow the width in the main scanning direction of light to be reflected, the reflection surface sometimes includes, on both sides in the main scanning direction, travel inhibiting portions that inhibit traveling of the light.

### BRIEF DESCRIPTION OF THE DRAWINGS

FIG. 1 is a schematic diagram illustrating an image forming apparatus according to an embodiment;

FIG. 2 is a schematic diagram illustrating an image forming unit of the image forming apparatus illustrated in FIG. 1;

FIG. 3 is a sectional view illustrating a reading module of a scanner of the image forming apparatus;

FIG. 4 is an exterior perspective view illustrating a lens mirror array according to a first embodiment incorporated in the reading module illustrated in FIG. 3;

FIG. 5 is a diagram for explaining a method of applying light blocking ink to a travel inhibiting surface of the lens mirror array illustrated in FIG. 4;

FIG. 6 is a diagram of the lens mirror array illustrated in FIG. 5 viewed from a main scanning direction;

FIG. 7 is a perspective view illustrating a state in which the light blocking ink is applied to the travel inhibiting surface;

FIG. 8 is a diagram for explaining another method of providing a plurality of grooves on the travel inhibiting surface;

FIG. 9 is a diagram illustrating an evaluation result of the plurality of grooves provided on the travel inhibiting surface;

FIG. 10 is a diagram illustrating a lens mirror array according to a second embodiment; and

FIG. 11 is a diagram illustrating a lens mirror array according to a third embodiment.

### DETAILED DESCRIPTION

In some scanners, by projecting a portion of the optical element to the outer side and providing the reflection surface at the top of the projecting portion, light blocking films can be provided on side surfaces of the projecting portion (surfaces continuing to both sides in the main scanning direction of the reflection surface). In this case, the light blocking films provided on the side surfaces of the projecting portion function as the travel inhibiting portions. However, if such projecting portions are provided in the optical element, steps on both the sides in the main scanning direction of the reflection surface increase in size. If the lens mirror array is formed using a die, a flow of resin is disturbed by the steps to make it difficult to secure the shape accuracy of the reflection surface.

In contrast, there is also a method of providing recesses having predetermined width on both sides across the reflection surface in the main scanning direction and forming light blocking films in the recesses to provide travel inhibiting portions on both the sides of the reflection surface. However, if recesses are provided between reflection surfaces, portions opposed to the recesses of a die for molding the lens mirror array project and portions opposed to the reflection surfaces are formed as concavities. Therefore, it is difficult to finish the bottom surfaces of the concavities. It is difficult to improve surface accuracy of the reflection surfaces of the lens mirror array opposed to the concavities.

In particular, if the reflection surfaces are free curved surfaces, higher surface accuracy is necessary compared with if the reflection surfaces are flat surfaces. Therefore, it is difficult to provide projecting portions and the recesses between the reflection surfaces and provide the travel inhibiting portions.

In general, according to one embodiment, a lens mirror array includes a plurality of optical elements arrayed in a main scanning direction. Each of the optical elements includes an incident surface, at least one reflection surface, and an emission surface. The incident surface transmits and converges light made incident thereon. The reflection surface has positive optical power for reflecting and converging the light made incident via the incident surface. The emission surface emits the light reflected by the reflection surface. The lens mirror array includes a plurality of grooves and a light blocking member. The plurality of grooves are provided among a plurality of the reflection surfaces arranged in the main scanning direction of the plurality of optical elements. The light blocking member is provided in the plurality of grooves.

An image forming apparatus 100 according to an embodiment is explained below with reference to the drawings. Note that, in the drawings referred to in the following explanation of embodiments, scales of units are sometimes changed as appropriate. In the drawings referred to in the following explanation of the embodiments, components are sometimes omitted in order to facilitate understanding of the explanation.

The image forming apparatus 100 in this embodiment is, for example, an MFP (multifunction peripheral). The image forming apparatus 100 includes a printing function, a scan function, a copy function, a decoloring function, and a facsimile function. The printing function is a function of forming a toner image on paper P. The scan function is a function of reading an image from an original document or the like on which the image is formed. The copy function is, for example, a function of printing the image read from the original document or the like using the scan function on the paper P using the printing function. The decoloring function is a function of decoloring an image formed on the paper P by a decolorable developer.

The image forming apparatus 100 includes a printer 10, a scanner 20, and an operation panel 30.

The printer 10 includes a plurality of paper feeding cassettes 11, a manual feed tray 12, and a plurality of paper feeding rollers 13. The paper feeding cassettes 11 store the paper P used for printing. The manual feed tray 12 is a tray for manually feeding the paper P. The paper feeding rollers 13 rotate to thereby selectively pick up the paper P from any one of the paper feeding cassettes 11 and the manual feed tray 12.

The printer 10 includes four toner cartridges 141, 142, 143, and 144, four image forming units (e.g., image formers, etc.) 151, 152, 153, and 154, an optical scanning device 16, a transfer belt 17, a secondary transfer roller 18, and a fixing unit (e.g., a fixer, etc.) 19.

The toner cartridges 141 to 144 respectively store toners to be supplied to the image forming units 151 to 154. The toner cartridge 141 stores yellow (Y) toner. The toner cartridge 142 stores magenta (M) toner. The toner cartridge 143 stores cyan (C) toner. The toner cartridge 144 stores black (K) toner. A combination of the colors of the toners is not limited to YMCK and may be a combination of other colors. The toners may be toners that are decolored at temperature higher than a predetermined temperature.

The image forming units 151 to 154 respectively receive supply of the toners from the toner cartridges 141 to 144 and form toner images having different colors. The image forming unit 151 forms a yellow (Y) toner image. The image forming unit 152 forms a magenta (M) toner image. The image forming unit 153 forms a cyan (C) toner image. The image forming unit 154 forms a black (K) toner image.

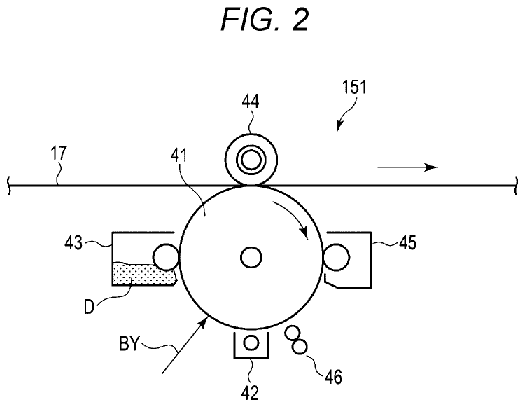

The image forming units 151 to 154 have the same configuration except the difference of the toners. Accordingly, here, the image forming unit 151 for yellow is representatively explained with reference to FIG. 2. The image forming units 152, 153, and 154 function similarly to the image forming unit 151 for yellow.

The image forming unit 151 for yellow includes a photoconductive drum 41, a charging device 42, a developing device 43, a primary transfer roller 44, a cleaner 45, and a charge removing lamp 46.

The photoconductive drum 41 includes a surface that receives a light beam BY irradiated from the optical scanning device 16. The optical scanning device 16 forms an electrostatic latent image on the surface of the photoconductive drum 41. The charging device 42 charges the surface of the photoconductive drum 41 with positive charges. The developing device 43 develops the electrostatic latent image on the surface of the photoconductive drum 41 using yellow toner D supplied from the toner cartridge 141. That is, the developing device 43 forms a yellow toner image on the surface of the photoconductive drum 41.

The image forming unit 151 includes a primary transfer roller 44 in a position opposed to the photoconductive drum 41 across the transfer belt 17. The primary transfer roller 44 generates a transfer voltage between the primary transfer roller 44 and the photoconductive drum 41. Consequently, the primary transfer roller 44 transfers (e.g., primarily transfers) the yellow toner image on the surface of the photoconductive drum 41 onto the surface of the transfer belt 17 that is in contact with the photoconductive drum 41.

The cleaner 45 removes the toner remaining on the surface of the photoconductive drum 41. The charge removing lamp 46 removes electric charges remaining on the surface of the photoconductive drum 41.

The optical scanning device 16 irradiates, according to image data input thereto, the surfaces of photoconductive drums 41 of the image forming units 151, 152, 153, and 154 respectively with light beams BY, BM, BC, and BK. The light beams BY, BM, BC, and BK are respectively based on image data of colors obtained by separating the image data into Y, M, C, and K colors.

The optical scanning device 16 emits the light beam BY and forms an electrostatic latent image for yellow on the surface of the photoconductive drum 41 of the image forming unit 151 according to image data of a Y component. Similarly, the optical scanning device 16 emits the light beams BM, BC, and BK and forms electrostatic latent images for the colors on the surfaces of the photoconductive drums 41 of the image forming units 152, 153, and 154 according to image data of M, C, and K components.

Note that the image data input to the optical scanning device 16 is, for example, image data read from an original document or the like by the scanner 20. Alternatively, the image data input to the optical scanning device 16 is image data transmitted from an apparatus different from the image forming apparatus 100 to the image forming apparatus 100.

The transfer belt 17 is endlessly stretched and rotates if the driving roller 171 wound with the transfer belt 17 is rotated. The transfer belt 17 rotates to thereby convey color toner images formed to be superimposed on the surface of the transfer belt 17 by the image forming units 151 to 154 to a transfer region opposed to the secondary transfer roller 18.

The secondary transfer roller 18 is opposed to a driving roller 171 across the transfer belt 17. The secondary transfer roller 18 transfers (secondarily transfers) the toner images formed on the transfer belt 17 onto the paper P passing between the transfer belt 17 and the secondary transfer roller 18.

The fixing unit (e.g., the fixer, etc.) 19 heats and pressurizes the paper P. The fixing unit 19 includes a heating roller 191 and a pressurizing roller 192 opposed to each other across a conveyance path for the paper P. The heating roller 191 includes a heat source such as a heater. The heating roller 191 heated by the heat source heats the paper P. The pressurizing roller 192 pressurizes the paper P passing between the pressurizing roller 192 and the heating roller 191. Accordingly, the fixing unit 19 fixes the toner images transferred on the paper P.

Besides, the printer 10 includes a duplex unit (e.g., duplex device, dual printer, etc.) 50 and a paper discharge tray 60. The duplex unit 50 enables printing on the rear surface of the paper P. The duplex unit 50 switches back the paper P to thereby reverse the front and the rear of the paper P and feeds the paper P into the transfer region between the transfer belt 17 and the secondary transfer roller 18. The paper discharge tray 60 receives the paper P discharged if the printing ends.

The scanner 20 reads an image from an original document or the like. The scanner 20 includes a reading module (e.g., a reader, etc.) 70 and a document feeding device (e.g., a feeder, etc.) 80.

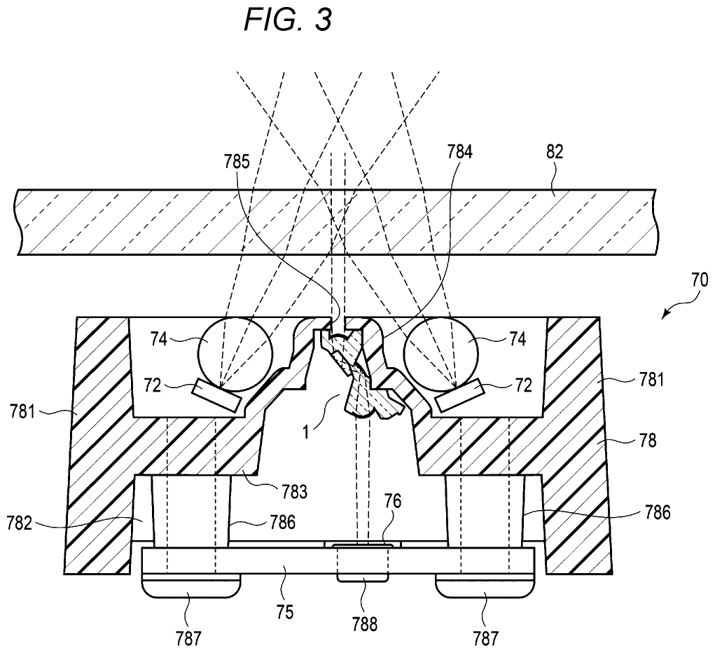

The reading module 70 shines illumination light on the surface of an original document having a reading target image (hereinafter referred to as original document surface), receives reflected light of the illumination light with an image sensor 76 (FIG. 3), and converts the reflected light into a digital signal. Consequently, the reading module 70 reads the image from the original document surface. The reading module 70 includes a lens mirror array 1 that guides the reflected light reflected from the original document to the image sensor 76.

The document feeding device 80 is, for example, an ADF (auto document feeder). The document feeding device 80 conveys original documents placed on an original document tray 81 one after another through an original document glass 82. The reading module 70 reads an image from an original document conveyed to the original document glass 82. The document feeding device 80 may include another reading module for reading an image from the rear surface of the original document.

The operation panel 30 is a man-machine interface (e.g., a user interface, etc.) that performs input and output between the image forming apparatus 100 and an operator of the image forming apparatus 100. The operation panel 30 includes, for example, a touch panel 31 and an input device (e.g., an input interface, etc.) 32.

The touch panel 31 is obtained by stacking a display such as a liquid crystal display or an organic EL display and a pointing device operated by touch input. The display of the touch panel 31 displays a screen for notifying various kinds of information to the operator of the image forming apparatus 100. The touch panel 31 receives touch operation by the operator.

The input device 32 receives operation by the operator of the image forming apparatus 100. The input device 32 is, for example, a keyboard, a keypad, or a touch pad.

As illustrated in FIG. 3, the reading module 70 includes the lens mirror array 1 according to a first embodiment, two reflection plates 72, two light guide bodies 74, an image sensor 76, and a holder 78. The holder 78 positions and holds the lens mirror array 1, the reflection plates 72, the light guide bodies 74, and the image sensor 76 (a substrate 75 on which the image sensor 76 is mounted).

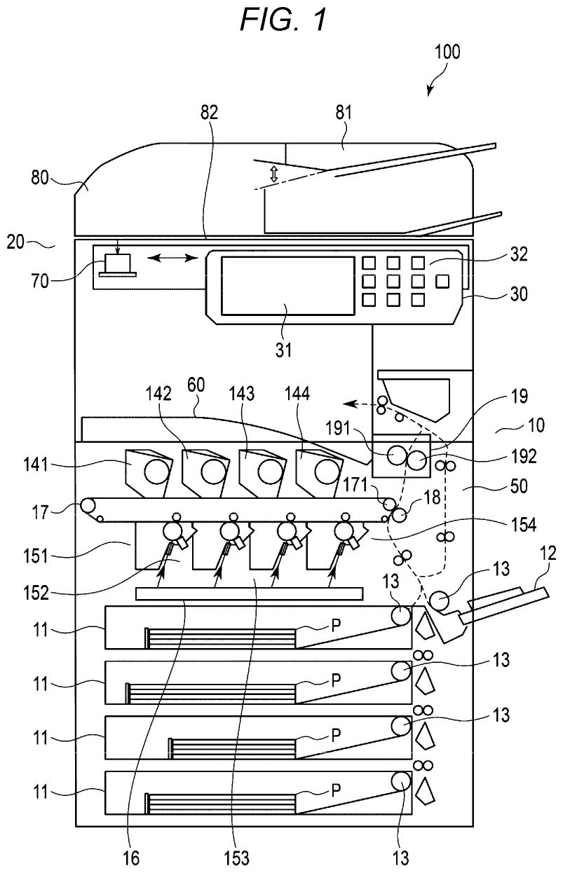

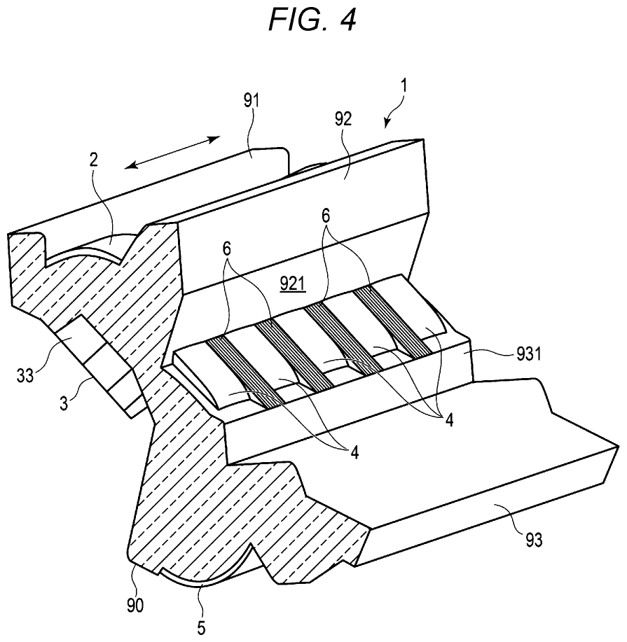

As illustrated in FIG. 4, the lens mirror array 1 has long structure (only a part of which is illustrated in FIG. 4) extending in a main scanning direction (an arrow direction). The lens mirror array 1 can be formed by integral molding by resin using a die. The lens mirror array 1 causes the image sensor 76 to form an erected image of an image on an original document surface. Therefore, it is possible to read the entire image on the original document surface with the image sensor 76 by moving the reading module 70 in a sub-scanning direction indicated by an arrow in FIG. 1 along the original document glass 82.

The image sensor 76 has a long structure extending in the main scanning direction. The image sensor 76 is a line sensor in which a plurality of imaging elements for converting light into an electric signal are linearly arrayed (e.g., positioned, arranged, etc.) in the main scanning direction. The image sensor 76 is one or a plurality of line sensors. The image sensor 76 can be configured by, for example, a charge coupled device (CCD), a complimentary metal oxide semiconductor (CMOS), or other imaging elements.

The holder 78 has long structure extending in the main scanning direction. The holder 78 can be formed by integral molding by resin using a die. The holder 78 includes a pair of sidewalls 781 disposed in the main scanning direction, a pair of end walls 782 (only the end wall 782 on the depth side is illustrated in FIG. 3) disposed at both the end portions in the longitudinal direction of the sidewalls 781, and a partition wall 783 connecting an inner surface of an intermediate portion in the up-down direction of the pair of sidewalls 781 and an inner surface of an intermediate portion in the up-down direction of the pair of end walls 782. A swelling portion 784 swelling upward is present in an intermediate portion in the sub-scanning direction (e.g., the left-right direction in FIG. 4) of the partition wall 783. The swelling portion 784 has long structure extending in the main scanning direction.

The swelling portion 784 of the holder 78 includes, substantially in the center in the sub-scanning direction, a rectangular slit-like diaphragm aperture 785 extending in the main scanning direction. The diaphragm aperture 785 allows the reflected light reflected from the original document surface to pass, narrows the width in the sub-scanning direction of the reflected light, and guides the reflected light to the lens mirror array 1. The holder 78 holds the lens mirror array 1 on the inner side of the swelling portion 784, that is, the lower side in FIG. 4 of the diaphragm aperture 785. The width in the sub-scanning direction of the diaphragm aperture 785 is smaller than the width of the reflected light, which is reflected from the original document and having passed through the diaphragm aperture 785, made incident on a plurality of incident-side lens surfaces 2 (FIG. 4) of the lens mirror array 1. The lens mirror array 1 is disposed such that a sub-scanning direction optical axis of the incident-side lens surfaces 2 passes the center in the sub-scanning direction of the diaphragm aperture 785.

The holder 78 holds the reflection plates 72 and the light guide bodies 74 on both sides across the swelling portion 784 in the sub-scanning direction, on the inner side of the two sidewalls 781, and above the partition wall 783. Illustration and explanation of a holding structure for the reflection plates 72 and the light guide bodies 74 are omitted.

Each of the reflection plates 72 has, for example, a long rectangular plate shape extending in the main scanning direction. The reflection plate 72 includes a reflection surface opposed to a not-illustrated light diffusing section of each of the light guide bodies 74 provided with unevenness or applied with white ink. The white ink is applied to or white resin is formed in a rectangular plate shape on the reflection surface of the reflection plate 72. The reflection plate 72 has a function of reflecting light leaking from the light diffusing section of the light guide body 74 to return the light to the light guide body 74.

The light guide body 74 is, for example, substantially columnar transparent resin long in the main scanning direction and includes the light diffusing section explained above in the longitudinal direction in a part of the surface of the light guide body 74. The light guide body 74 guides light emitted from a LED light source or the like disposed at one end in the longitudinal direction of the light guide body 74. The reflection plate 72 reflects the light leaking from the light diffusing section of the light guide body 74 and returns the light to the light guide body 74.

Since the swelling portion 784 of the partition wall 783 of the holder 78 is present between the two light guide bodies 74, the two light guide bodies 74 need to be disposed to be separated a fixed distance from each other in the sub-scanning direction such that the swelling portion 784 does not form a shadow of illumination light. On the other hand, if the two light guide bodies 74 are separated in the sub-scanning direction, an angle of the illumination light shining on the image reading region on the original document surface increases and a change in illuminance in the case in which the distance between the original document glass 82 and the original document surface changes increases. Therefore, the two light guide bodies 74 are desirably disposed as close as possible to each other in the sub-scanning direction.

The holder 78 includes a plurality of bosses 786 projected downward from the lower surface of the partition wall 783 illustrated in FIG. 4. The bosses 786 are provided on both the sides in the sub-scanning direction of the swelling portion 784, for example, in three places at both the ends and in the center in the main scanning direction of the partition wall 783. These six bosses 786 are respectively bosses for fixing the substrate 75 to the holder 78 using screws 787. Note that the holder 78 includes a plurality of bosses 88 for positioning the substrate 75 in the holder 78.

The lens mirror array 1 is explained below with reference to FIGS. 3 and 4. In FIG. 3, a direction orthogonal to the paper surface is the main scanning direction and the left-right direction in which the reading module 70 moves is the sub-scanning direction. FIG. 4 is a partially enlarged perspective view illustrating a part of the lens mirror array 1. The main scanning direction is indicated by an arrow.

The lens mirror array 1 has structure in which a plurality of transparent optical elements 90 having substantially the same shape are integrally arrayed side by side in the main scanning direction. An effective surface of each of the optical elements 90 has a shape that is surface symmetrical to an imaginary center surface passing the center in the main scanning direction of the optical element 90 and orthogonal to the main scanning direction. Besides the plurality of optical elements 90, the lens mirror array 1 includes, at both the ends in the longitudinal direction thereof, not-illustrated extended portions that an operator can touch if grasping the lens mirror array 1. The lens mirror array 1 in this embodiment can be formed by integral molding of transparent resin. The lens mirror array 1 can be formed by transparent glass as well.

Each of the optical elements 90 of the lens mirror array 1 guides diffused light diffused from an object point to form an image at an image forming point present on an image surface. One optical element 90 causes lights from a plurality of object points arranged in the main scanning direction to form images on the image surface. For example, one optical element 90 causes lights from object points arranged in width twice to five times as large as a pitch in the main scanning direction of the optical elements 90 to form images on the image surface. The optical elements 90 of the lens mirror array 1 respectively reflect incident lights twice and emit the incident lights and form erected images of object points at image forming points.

Each of the optical elements 90 of the lens mirror array 1 includes, on the surface thereof, the incident-side lens surface 2 (e.g., an incident surface), an upstream-side reflection surface 3, a downstream-side reflection surface 4 (e.g., at least one reflection surface), and an emission-side lens surface 5 (e.g., an emission surface). The incident-side lens surface 2, the downstream-side reflection surface 4, and the emission-side lens surface 5 are free curved surfaces convex to the outer side. The upstream-side reflection surface 3 is a flat surface. Each of the other surfaces of the plurality of optical elements 90 forms one flat surface connected in the main scanning direction over the entire length of the lens mirror array 1.

The incident-side lens surface 2 of the optical element 90 is opposed to the diaphragm aperture 785 present in the swelling portion 784 of the holder 78. In other words, the lens mirror array 1 is fixed to the swelling portion 784 in a state illustrated in FIG. 3 in which the incident-side lens surfaces 2 of the plurality of optical elements 90 are opposed to the diaphragm aperture 785. The incident-side lens surface 2 has positive optical power for making light reflected on the original document surface and having passed through the diaphragm aperture 785 incident and refracting and converging the incident light.

The upstream-side reflection surface 3 is adjacent to the opposite side of a projecting portion 91 with respect to the incident-side lens surface 2. That is, the upstream-side reflection surface 3 is located on an optical path of incident light made incident via the incident-side lens surface 2. The upstream-side reflection surface 3 totally reflects light made incident via the incident-side lens surface 2 toward the downstream-side reflection surface 4. The upstream-side reflection surface 3 is present at the top of a projecting portion formed by projecting a part of the optical element 90 outward. A light blocking film 33 is applied to a side surface of the projecting portion continuing to the outer side in the main scanning direction of the upstream-side reflection surface 3 and a side surface of the projecting portion continuing to an end edge of the upstream-side reflection surface 3 separated from the incident-side lens surface 2.

The downstream-side reflection surface 4 continues to the opposite side of a projecting portion 92 with respect to the incident-side lens surface 2. That is, the downstream-side reflection surface 4 is located on an optical path of reflected light reflected on the upstream-side reflection surface 3. The downstream-side reflection surface 4 totally reflects the reflected light reflected by the upstream-side reflection surface 3 toward the emission-side lens surface 5. The downstream-side reflection surface 4 is a free curved surface having positive optical power for reflecting and converging light. The width in the main scanning direction of the downstream-side reflection surface 4 is smaller than the width of the optical element 90.

The emission-side lens surface 5 continues to the opposite side of a projecting portion 93 with respect to the downstream-side reflection surface 4. That is, the emission-side lens surface 5 is located on an optical path of reflected light reflected on the downstream-side reflection surface 4. The emission-side lens surface 5 is a free curved surface having positive optical power for transmitting and converging the reflected light reflected on the downstream-side reflection surface 4.

The lens mirror array 1 includes a substantially rectangular plurality of travel inhibiting surfaces 6 among downstream-side reflection surfaces 4 of the plurality of optical elements 90. Each of the travel inhibiting surfaces 6 is a substantially flat surface provided over two optical elements 90 adjacent to each other in the main scanning direction and has a predetermined width in the main scanning direction. For example, the width in the main scanning direction of the travel inhibiting surface 6 is slightly smaller than the width in the main scanning direction of the downstream-side reflection surface 4. The travel inhibiting surface 6 may be, for example, a column surface in which a crossing line of an imaginary surface orthogonal to the center surface of the optical element 90 and the travel inhibiting surface 6 is continued in a direction orthogonal to the main scanning direction.

The travel inhibiting surface 6 is a substantially flat surface continuing to, almost without any step (e.g., drop off, etc.), the downstream-side reflection surface 4 of another optical element 90 adjacent to the downstream-side reflection surface 4 of the optical element 90 in the main scanning direction. In other words, the lens mirror array 1 includes a flat plurality of travel inhibiting surfaces 6 without steps among a plurality of downstream-side reflection surfaces 4. The travel inhibiting surface 6 inhibits light made incident thereon or causes the light to travel in a direction different from a direction toward the image sensor 76. Therefore, by providing the travel inhibiting surfaces 6 among the plurality of downstream-side reflection surfaces 4 as in this embodiment, it is possible to limit an effective range in the main scanning direction of the reflected light reflected on the downstream-side reflection surface 4.

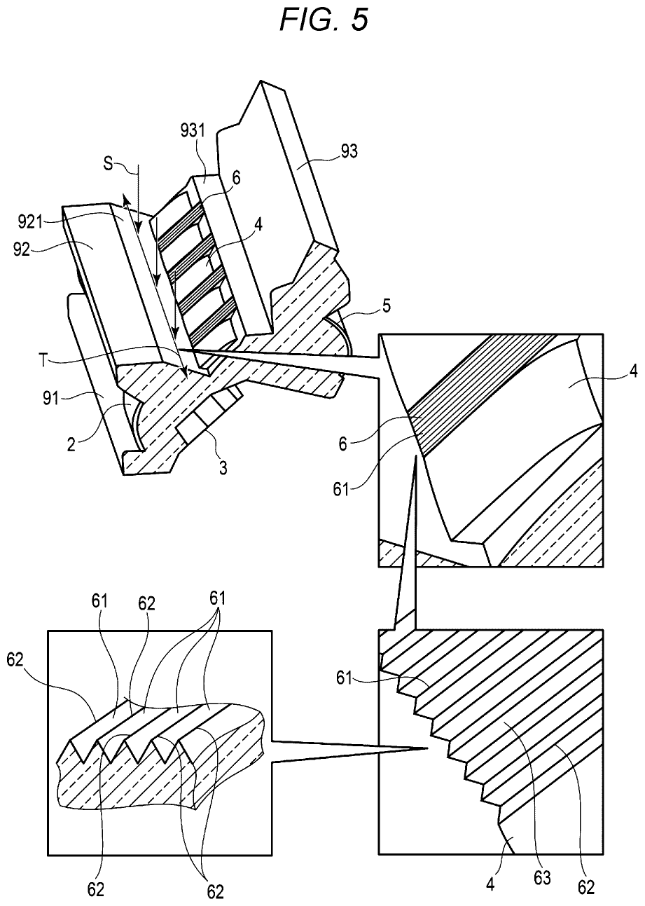

The travel inhibiting surface 6 includes, for example, a plurality of grooves 61 having a shape (e.g., jagged, serrated, etc.) illustrated in FIG. 5. The plurality of grooves 61 extend in parallel to one another in a direction orthogonal to the main scanning direction and are arranged at a predetermined pitch in close contact in the main scanning direction over the entire width in the main scanning direction of the travel inhibiting surface 6. Both the ends in the longitudinal direction of the plurality of grooves 61 extend to the end edge of the travel inhibiting surface 6. The plurality of grooves 61 are, for example, grooves formed among a plurality of triangular prisms of a structure (see FIG. 5) in which a plurality of triangular prisms, one side of which is approximately 6 μm, are arranged in close contact with one another in a direction crossing an axial direction of the triangular prisms. A sectional shape of the grooves 61 is not limited to a regular triangle in this embodiment and may be another sectional shape if the grooves 61 are fine enough to make it possible to suck (so as to receive) light blocking ink with capillarity (i.e., capillary action).

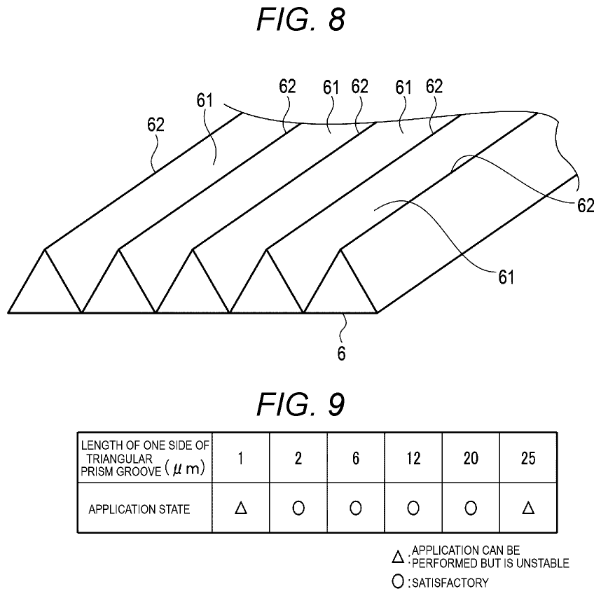

In this embodiment, the plurality of grooves 61 have a shape obtained by engraving the triangular prism-like grooves explained above on the travel inhibiting surface 6 continuing to the downstream-side reflection surface 4 without a step. Therefore, there is no entity of the travel inhibiting surface 6. An imaginary surface including a plurality of triangular prism ridge portions 62 is equivalent to the travel inhibiting surface 6. Alternatively, as illustrated in FIG. 8, the plurality of grooves 61 may be grooves formed among a plurality of triangular prisms of a structure in which a triangular prism-like plurality of protrusions are projected from the travel inhibiting surface 6. In this case, an imaginary surface including trough bottoms of the plurality of grooves 61 is equivalent to the travel inhibiting surface 6.

The lens mirror array 1 includes, on the surface of the projecting portion 92, one ink application surface 921 connected to the plurality of travel inhibiting surfaces 6 on one end side in the longitudinal direction of the plurality of grooves 61. The ink application surface 921 is a flat surface extending in the main scanning direction over substantially the entire length of the lens mirror array 1. The ink application surface 921 is a surface inclined to, with respect to the plurality of travel inhibiting surfaces 6, a side where the plurality of grooves 61 are provided and is, for example, a surface disposed at an obtuse angle with respect to the travel inhibiting surface 6. One end side of the plurality of downstream-side reflection surfaces 4 is also connected to the ink application surface 921.

On the other hand, on the other end side in the longitudinal direction of the plurality of grooves 61, the travel inhibiting surface 6 is connected to a plane 931 of the projecting portion 93. In contrast, the other end side of the plurality of downstream-side reflection surface 4 does not reach the plane 931 of the projecting portion 93. The plane 931 of the projecting portion 93 is a surface continuing to the plurality of travel inhibiting surfaces 6 while being inclined to the opposite side of the side where the plurality of grooves 61 are provided.

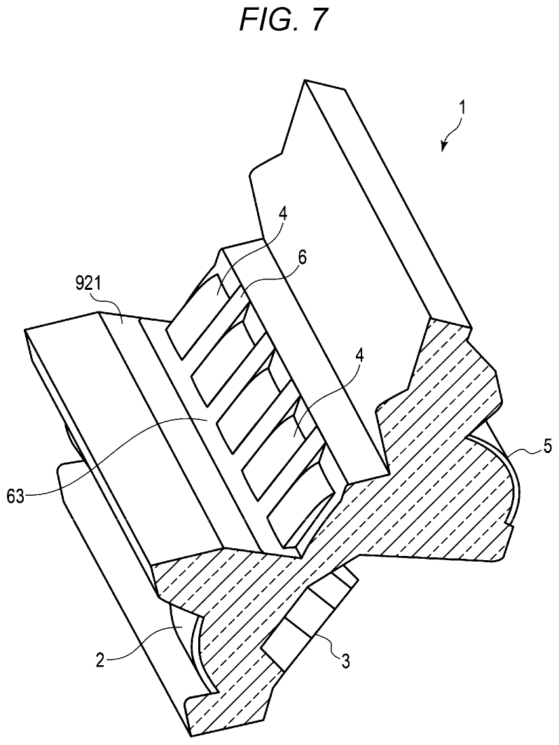

The lens mirror array 1 includes a light blocking member 63 (see FIG. 7) provided in the plurality of grooves 61 of the plurality of travel inhibiting surfaces 6.

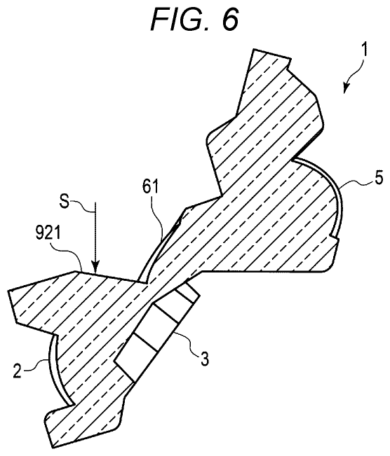

If the light blocking member 63 is provided in the plurality of grooves 61, as illustrated in FIGS. 5 to 7, the lens mirror array 1 is disposed in a posture in which the ink application surface 921 is substantially horizontally disposed and faces upward. The light blocking ink is applied to the ink application surface 921. At this time, it is desirable to dispose the lens mirror array 1 in a posture in which the ink application surface 921 is slightly inclined downward toward one ends of the plurality of grooves 61. The light blocking ink is ejected toward the ink application surface 921 from a direction indicated by an arrow S in FIGS. 5 and 6 and applied in an arrow T direction in FIG. 5.

The light blocking ink applied to the ink application surface 921 is sucked from one end side of the plurality of grooves 61 by the capillarity of the plurality of grooves 61 provided on the plurality of travel inhibiting surfaces 6 connected to the ink application surface 921 and wetly spreads to the other ends of the plurality of grooves 61 against the gravity. If the plurality of grooves 61 are not provided on the travel inhibiting surface 6, since the ink application surface 921 and the travel inhibiting surface 6 are connected at an obtuse angle, the light blocking ink on the ink application surface 921 does not wetly spread to the travel inhibiting surface 6.

It is possible to form the light blocking member 63 on the travel inhibiting surface 6 by hardening the light blocking ink after causing the light blocking ink to wetly spread to the plurality of grooves 61. A state in which the light blocking member 63 is provided in the ink application surface 921 and the plurality of grooves 61 on the travel inhibiting surface 6 is illustrated in FIG. 7. A light blocking ink of a UV curing type or a light blocking ink of a thermosetting type can be used as the light blocking ink. The light blocking member 63 has light reflectance smaller than at least the light reflectance of the downstream-side reflection surface 4.

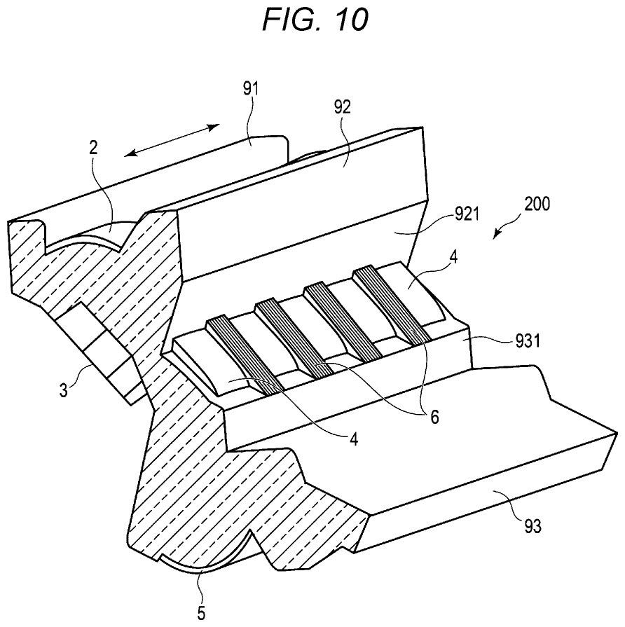

In order to check a proper size of the plurality of grooves 61 for forming the light blocking member 63 having a stable shape, the length of one side of the triangular prism in the cross section of the groove 61 was variously changed and an application state of the light blocking ink on the travel inhibiting surface 6 was observed. A result of the observation is illustrated in FIG. 9.

If the length of one side of the triangular prism-like groove 61 was set to approximately 1 μm and approximately 25 μm, the light blocking ink was successfully applied to the travel inhibiting surface 6 but the shape of the light blocking member 63 was unstable. In contrast, if the length of one side of the triangular prism-like groove 61 was set to approximately 2 μm, approximately 6 μm, approximately 12 μm, and approximately 20 μm, the light blocking ink satisfactorily wetly rose from one ends (e.g., the lower ends) to the other ends (e.g., the upper ends) of the plurality of grooves 61 and the light blocking member 63 having a stable shape was successfully formed on the travel inhibiting surface 6. Accordingly, the proper size of one side of the triangular prism-like plurality of grooves 61 on the travel inhibiting surface 6 is approximately 2 μm to approximately 20 μm.

The lens mirror array 1 explained above functions as explained below.

Light reflected on the original document surface is made incident on the incident-side lens surfaces 2 of the plurality of optical elements 90. That is, reflected light from the surface of the original document placed at an object point is made incident on the incident-side lens surface 2. The incident-side lens surface 2 refracts and converges the incident light and forms an intermediate inverted image.

The upstream-side reflection surface 3 reflects the incident light made incident via the incident-side lens surface 2 toward the downstream-side reflection surface 4. The downstream-side reflection surface 4 further reflects the light reflected on the upstream-side reflection surface 3 toward the emission-side lens surface 5.

The emission-side lens surface 5 emits the light reflected on the downstream-side reflection surface 4 toward the image sensor 76 disposed at an image forming point. The emission-side lens surface 5 cooperates with the downstream-side reflection surface 4 and forms an erected image, which is an inverted image of the intermediate inverted image formed by the incident-side lens surface 2. Emitted light emitted from the emission-side lens surface 5 forms an image on a light receiving surface of the image sensor 76 disposed at the image forming point.

If the travel inhibiting surfaces 6 are provided among the downstream-side reflection surfaces 4 as in this embodiment, a range in the main scanning direction of reflected lights reflected on the downstream-side reflection surfaces 4 can be limited. That is, if the lens mirror array 1 in this embodiment is used, the width in the main scanning direction of the downstream-side reflection surface 4 is narrowed by the light blocking member 63 provided on the travel inhibiting surface 6 and the reflected light reflected on the downstream-side reflection surface 4 is limited in the main scanning direction. Therefore, an angle in the main scanning direction of a ray reaching an image surface can be reduced. An NA (numerical aperture) decreases and a depth of field can be increased.

If the travel inhibiting surfaces 6 are provided among the downstream-side reflection surfaces 4 not via steps as in the lens mirror array 1 in this embodiment, a flow of resin in a portion where the downstream-side reflection surface 4 and the travel inhibiting surface 6 cross can be smoothed and shape accuracy of the downstream-side reflection surface 4 can be improved if the lens mirror array 1 is formed using a die. Since a step is not provided between the downstream-side reflection surface 4 and the travel inhibiting surface 6, a portion of the die that molds the downstream-side reflection surface 4 does not need to be formed as a recess. It is possible to facilitate finishing of this portion and improve surface accuracy.

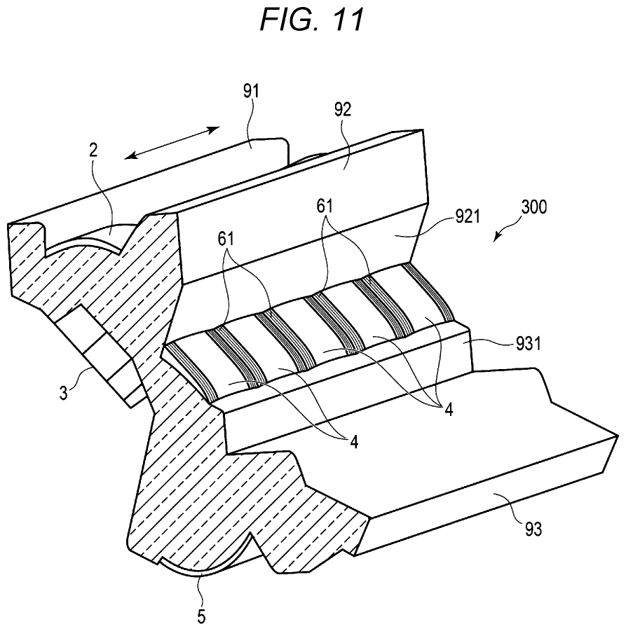

Alternatively, as in a lens mirror array 200 according to a second embodiment illustrated in FIG. 10, the travel inhibiting surfaces 6 provided among the plurality of downstream-side reflection surfaces 4 may be projected further to the outer side than the downstream-side reflection surfaces 4 and the plurality of grooves 61 may be provided on the travel inhibiting surfaces 6. In this case, the portion of the die that molds the downstream-side reflection surface 4 can be further projected than a portion where the travel inhibiting surface 6 is formed. It is possible to further facilitate finishing of the portion of the die opposed to the downstream-side reflection surface 4. The surface shape of the downstream-side reflection surface 4 of the lens mirror array 200 can be more highly accurately formed.

According to the first and second embodiments explained above, it is possible to satisfactorily wetly spread the light blocking ink to the travel inhibiting surface 6 using the capillarity of the plurality of grooves 61 provided on the travel inhibiting surface 6. The shape of the light blocking member 63 can be stabilized. Since the plurality of grooves 61 are provided over the entire width in the main scanning direction of the travel inhibiting surface 6, it is possible to stabilize the width in the main scanning direction of the light blocking member 63. Therefore, according to the first and second embodiments, it is possible to stabilize a range of reflected light reflected on the downstream-side reflection surface 4, increase contrast in a best position on the image surface, increase the depth of field, and obtain satisfactory optical performance.

Note that, in the first and second embodiments, the travel inhibiting surfaces 6 including the plurality of grooves 61 are provided among the downstream-side reflection surfaces 4 of the lens mirror array 1 (200). However, as in a lens mirror array 300 according to a third embodiment illustrated in FIG. 11, the plurality of grooves 61 may be provided in a part of the plurality of downstream-side reflection surfaces 4 without providing the travel inhibiting surfaces 6. In this case, the plurality of grooves 61 only have to be provided at a fixed pitch in regions of predetermined width in the main scanning direction centering on an edge where two downstream-side reflection surfaces 4 adjacent in the main scanning direction cross. Since the downstream-side reflection surfaces 4 are free curved surfaces swelling to the outer side, the plurality of grooves 61 also have a shape curved along the free curved surfaces.

If the lens mirror array 300 according to the third embodiment is molded using a die, all that should be done is to, for example, before finishing a portion of the die opposed to the downstream-side reflection surface 4, form, in the die, a plurality of ridges (actually, a plurality of grooves are engraved) for molding the plurality of grooves 61 and, thereafter, finish the portion of the die opposed to the downstream-side reflection surface 4. The plurality of grooves 61 of the lens mirror array 300 only has to have a shape for enabling the light blocking ink to be sucked by capillarity. Since it is unnecessary to improve shape accuracy, the downstream-side reflection surface 4 only has to be finished. It is possible to facilitate manufacturing of the die.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A lens mirror array comprising a plurality of optical elements arrayed in a main scanning direction, the lens mirror array configured such that:
each of the optical elements includes
an incident surface that transmits and converges light made incident thereon;
at least one reflection surface having positive optical power for reflecting and converging the light made incident via the incident surface; and
an emission surface that emits the light reflected by the reflection surface, and
the lens mirror array comprises:
a plurality of grooves provided among a plurality of reflection surfaces arranged in the main scanning direction of the plurality of optical elements; and
a light blocking member provided in the plurality of grooves.

2. The lens mirror array according to claim 1, wherein a travel inhibiting surface having a predetermined width in the main scanning direction is present between the plurality of reflection surfaces, and the plurality of grooves are provided side by side in a width direction on the travel inhibiting surface.

3. The lens mirror array according to claim 2, wherein the travel inhibiting surface continues to the adjacent reflection surface in the main scanning direction without a step.

4. The lens mirror array according to claim 2, wherein the travel inhibiting surface projects further to an outer side than the adjacent reflection surface in the main scanning direction.

5. The lens mirror array according to claim 1, wherein the plurality of grooves are shaped to receive light blocking ink by capillary action and allow the light blocking ink to spread to the plurality of grooves, the light blocking ink being hardenable to form the light blocking member.

6. The lens mirror array according to claim 5, wherein the plurality of grooves are formed among a plurality of triangular prisms of a structure having one side being approximately 2 μm to approximately 20 μm in length, the plurality of triangular prisms being arranged be in contact in a direction crossing an axial direction of the triangular prisms.

7. The lens mirror array according to claim 2, wherein the plurality of grooves are shaped to receive light blocking ink through capillary action and to allow the light blocking ink to spread to the plurality of grooves, the light blocking ink being hardenable to form the light blocking member.

8. The lens mirror array according to claim 7, further comprising one ink application surface to which the light blocking ink is applied, the ink application surface being connected to a plurality of the travel inhibiting surfaces among the plurality of reflection surfaces on one end side of the plurality of grooves.

9. The lens mirror array according to claim 8, wherein the ink application surface is an inclined surface, with respect to the travel inhibiting surface, to a side where the plurality of grooves are provided.

10. The lens mirror array according to claim 9, wherein the ink application surface is a surface disposed at an obtuse angle with respect to the travel inhibiting surface.

11. The lens mirror array according to claim 9, wherein the plurality of grooves are provided at a fixed pitch in a plurality of regions of a predetermined width in the main scanning direction centering on an edge where two downstream-side reflection surfaces adjacent in the main scanning direction cross.

12. The lens mirror array according to claim 11, wherein the downstream-side reflection surfaces are free curved surfaces extending toward the outer side, and the plurality of grooves have a shape curved along the free curved surfaces.

13. The lens mirror array according to claim 2, the lens mirror array further comprising an ink application surface connected to the plurality of travel inhibiting surfaces on one end side in the longitudinal direction of the plurality of grooves.

14. The lens mirror array according to claim 1, wherein the at least one reflection surfaces includes a downstream-side reflection surface and upstream side reflection surface, wherein the downstream-side reflection surface is a free curved surface convex to the outer side and the upstream-side reflections surface is flat.

15. The lens mirror array according to claim 14, wherein the upstream-side reflection surface is adjacent to the opposite side of a projecting portion with respect to the incident-side lens surface.

16. The lens mirror array according to claim 14, wherein the downstream-side reflection surface totally reflects the reflected light reflected by the upstream-side reflection surface toward the emission surface.
